(19) United States
(12) Patent Application Publication
(10) Pub. No.: US 2023/0011859 A1
(43) Pub. Date: Jan. 12, 2023

(54) VEHICLE SEAT ATTACHMENT

(71) Applicant: Brose Fahrzeugteile SE & Co. Kommanditgesellschaft, Coburg, Coburg (DE)

(72) Inventors: Leo IOPPOLO, Washington Twp., MI (US); Sean SABO, West Bloomfield, MI (US)

(73) Assignee: Brose Fahrzeugteile SE & Co. Kommanditgesellschaft, Coburg, Coburg (DE)

(21) Appl. No.: 17/859,213

(22) Filed: Jul. 7, 2022

Related U.S. Application Data
(60) Provisional application No. 63/219,064, filed on Jul. 7, 2021.

(51) Int. Cl. B60N 2/68

(52) U.S. Cl. CPC B60N 2/682; B60N 2/686

(57) ABSTRACT

An attachment member configured to fix a first seat component to another seat component. The attachment member including a main body, a locking member, a first leg, and a second leg. The main body including a first side and a second side that opposes the first side. The locking member is disposed above the first side and the first and second legs extending from the second side of the main body. The second side and end portions of the first and second legs are collectively configured to sandwich the second seat component, and the locking member and the first side of the main body are collectively configured to sandwich the first seat component.

### CROSS-REFERENCE TO RELATED APPLICATIONS

This application claims the benefit of U.S. Provisional Application Serial No. 63/219,064 filed Jul. 7, 2021, the disclosure of which is hereby incorporated in its entirety by reference herein.

### TECHNICAL FIELD

The present disclosure relates to vehicle seats.

### BACKGROUND

Vehicle seats generally include a number of components and sub-assemblies that are assembled to one another to form a frame for the vehicle seat.

### SUMMARY

According to one embodiment, an attachment member configured to fix a first component to another component is provided. The attachment member may include a main body and a pair of legs. The main body may be configured to lie against a first component, such as a cushion pan, and the pair of legs may be configured to engage a second component, such as a tube. The attachment member may be rotated during installation so that the first and second legs provide opposing forces against the tube to fix the attachment member to the tube. The main body may include a number of locking features including a locking wedge and locking tabs. The locking wedge may bias the attachment member and end portions of the first and second legs to clamp the tube between the end portions of the legs and the main body. The locking tabs may be configured to engage one or more notches defined by the cushion pan. The locking tabs may be configured to spring into the one or more notches.

According to another embodiment, a seat assembly for use in a vehicle is provided. The seat assembly may include a cushion pan, a tube, and an attachment member. The attachment member may be configured to be at least partially inserted into an aperture of the cushion pan and rotated from an unlocked position to a locked position. The attachment member may include a main body, provided with a first side and a second side, a first leg and a second leg. At least a portion of the first side may be configured to lie against a portion of the cushion pan. The first leg and the second leg may each extend from the second side of the main body. In the unlocked position, the first and second legs may extend in a first direction parallel to a longitudinal axis of the tube and in the locked position, the first and second legs extend in a direction that may be substantially transverse to the first direction.

According to yet another embodiment, a method of assembling a vehicle seat assembly including a cushion pan and a cross tube configured to carry the cushion pan is provided. The method may include, providing an attachment member that may include a main body provided with a first side and a second side, opposing the first side, a pair of opposing legs extending from the second side of the main body, and a locking boss extending from the first side of the main body. The method may also include inserting the locking boss through an aperture defined by the cushion pan and rotating the main body so that the locking boss engages portions of the cushion pan, and the pair of opposing legs at least partially surround portions of the cross tube.

### BRIEF DESCRIPTION OF THE DRAWINGS

FIG. 1 illustrates a perspective view of an exemplary vehicle seat.

FIG. 2 illustrates a front perspective view of a portion of an exemplary vehicle seat.

FIG. 3 illustrates a top-perspective view of an exemplary attachment member.

FIG. 4 illustrates a bottom-perspective view of the exemplary attachment member.

FIG. 5 illustrates a top view of the exemplary attachment member.

FIG. 6 illustrates a plan view of the exemplary attachment member.

FIG. 7A illustrates a plan view of the exemplary attachment member attached is a tube of the vehicle seat.

FIG. 7B illustrates a plan view of the exemplary attachment member attached is a tube of the vehicle seat.

FIG. 8 illustrates a perspective view of an attachment member according to one or more embodiments.

FIG. 9 illustrates a perspective view of the attachment member illustrated in FIG. 8 in an uninstalled position.

FIG. 10 illustrates a perspective view of the attachment member illustrated in FIG. 8 in an uninstalled position.

FIG. 11 illustrates a perspective view of the attachment member illustrated in FIG. 8 in an installed position.

FIG. 12 illustrates an exploded view of a portion of the vehicle seat.

FIG. 13A illustrates a top-perspective view of a portion of the vehicle seat including the attachment member in an uninstalled position.

FIG. 13B illustrates a top-perspective view of a portion of the vehicle seat including the attachment member in an installed position.

FIG. 14A illustrates a bottom-perspective view of a portion of the vehicle seat including the attachment member in an uninstalled position.

FIG. 14B illustrates a bottom-perspective view of a portion of the vehicle seat including the attachment member in an installed position.

FIGS. 15A-15C illustrate schematic views of the attachment member disposed in a number of positions with respect to locking tabs.

FIG. 16 illustrates a perspective view of another attachment member according to one or more embodiments.

FIG. 17 illustrates a perspective view of the attachment member illustrated in FIG. 16.

FIG. 18 illustrates a perspective view of the attachment member fixed to a cushion pan in an installed position.

FIG. 19 illustrates a perspective view of the attachment member fixed to a cross tube in an installed position.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This invention is not limited to the specific embodiments and methods described below, as specific components and/or conditions may, of course, vary. Furthermore, the terminology used herein is used only for the purpose of describing particular embodiments of the present invention and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially” or “about” may be used herein to describe disclosed or claimed embodiments. The term “substantially” or “about” may modify a value or relative characteristic disclosed or claimed in the present disclosure. In such instances, “substantially” or “about” may signify that the value or relative characteristic it modifies is within ± 0%, 0.1%, 0.5%, 1%, 2%, 3%, 4%, 5% or 10% of the value or relative characteristic.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). The term “and/or” includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Portions of vehicle seats may be comprised of various components or sub-assemblies that are connected to one another to form a vehicle seat structure. Generally, one component may be attached to another component by one or more fasteners, such as self-tapping screws or bolts. Using threaded fasteners requires assembly equipment such as a torque gun and a torque monitoring program. Fasteners also require time for the operator to grasp, locate, and drive the fastener to the desired torque. Misalignment of the screw or bolt may result in cross-threading or not properly seating the fastener, all of which may require substantial effort to repair the fastened joint.

The present disclosure aims to provide a solution to the above-mentioned problems.

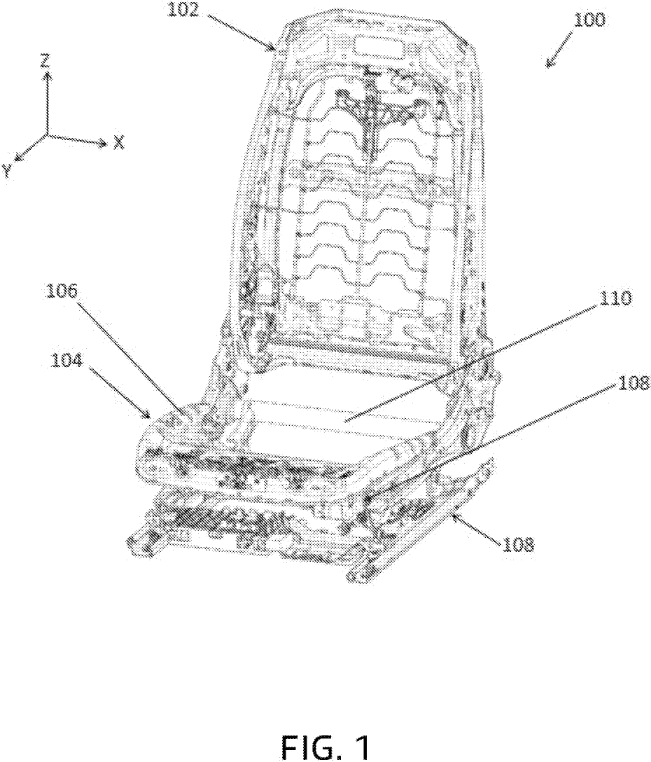

FIG. 1 illustrates a perspective view of an exemplary vehicle seat 100. The vehicle seat 100 may include a backrest assembly 102 that may be fixed to a cushion support assembly 104. The cushion support assembly 104 may include a cushion pan 106 that may be supported by or coupled to one or more cross-members such as a front cross-tube 108 or a rear cross-tube 110.

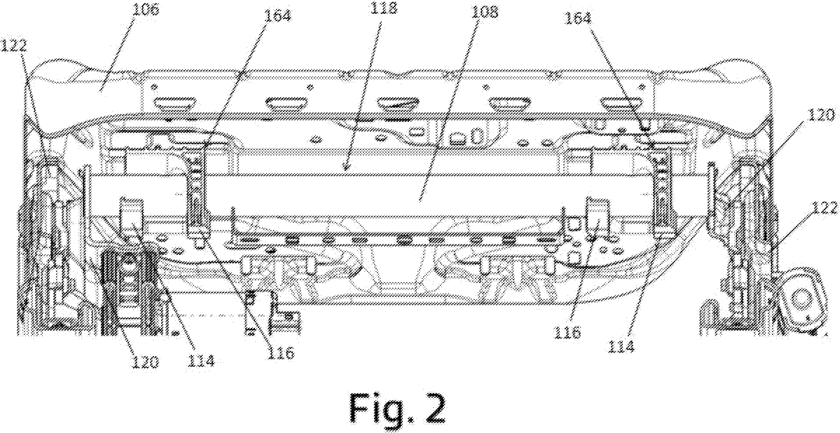

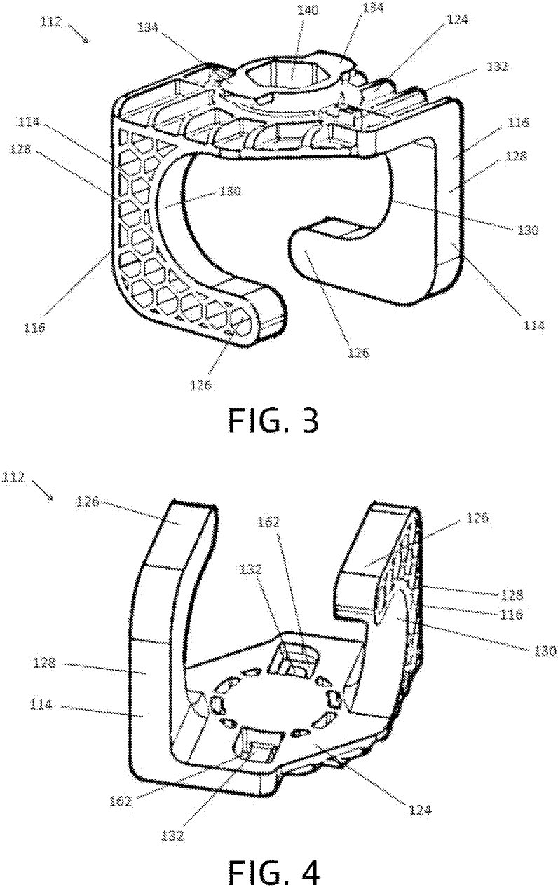

FIG. 2 illustrates a front perspective view of a portion of an exemplary vehicle seat 100. FIG. 3 illustrates a top-perspective view of an exemplary attachment member 112. As an example, the front cross-tube 108 may be part of an assembly such as a tilt tube assembly 118 that may be configured to pivot to tilt the cushion pan 106 to vary a position of the cushion pan 106 with respect to a user’s thighs. The tilt tube assembly 118 may include a pair of link arms 120 that may be pivotally fixed to side panels 122. The cushion pan 106 may be attached to the front cross-tube 108 may one or more attachment members 112. The attachment member 112 may include a main body 124 and a pair of legs 114, 116 extending therefrom.

The legs 114, 116 may include end portions 126 that may be spaced apart from the main body 124 and vertical portions 128 that may extend between the main body 124 and the end portions 126. The vertical portions 128 may include an inner curved portion 130 that may be configured to receive portions of a first component such as the front cross-tube 108. The attachment member 112 may include one or more locking tabs 132 that may be configured to engage a second component, such as the cushion pan 106. The end portions 126 may be configured to retain the cushion pan 106 to the front cross-tube 108 in a vertical direction. The vertical portions 128 may be configured to retain the position of the cushion pan 106 with respect to the front cross-tube 108 in a fore-aft direction.

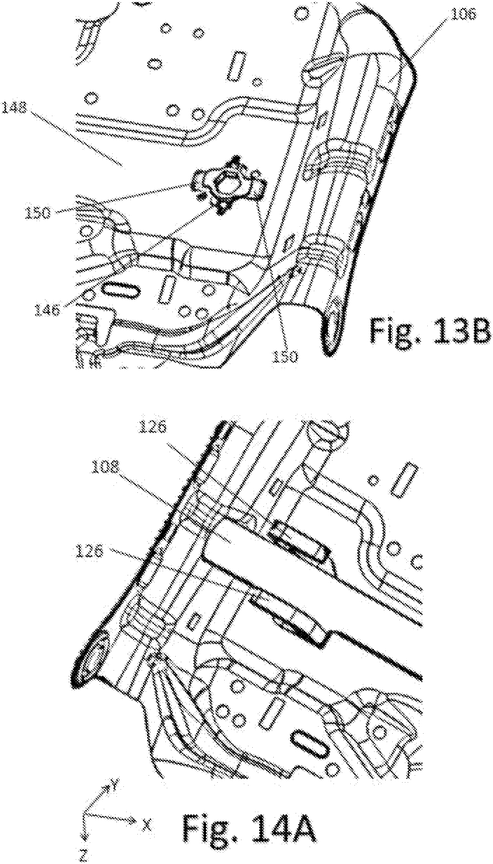

FIG. 4 illustrates a bottom-perspective view of the exemplary attachment member 112. In one or more embodiments, the main body 124 may define one or more (e.g., two) locking tab openings 162. The locking tab openings 162 may be configured to receive the locking tabs 132 as the locking tabs 132 are pressed against a bottom surface of the cushion pan 106 as the attachment member 112, 112′ is rotated from the unlocked position to the locked position. Upon the attachment member 112, 122′ being rotated to the locked position, the locking tabs 132 may be biased out of the locking tab openings 162 into the apertures 146 (FIG. 13B) defined by the cushion pan 106.

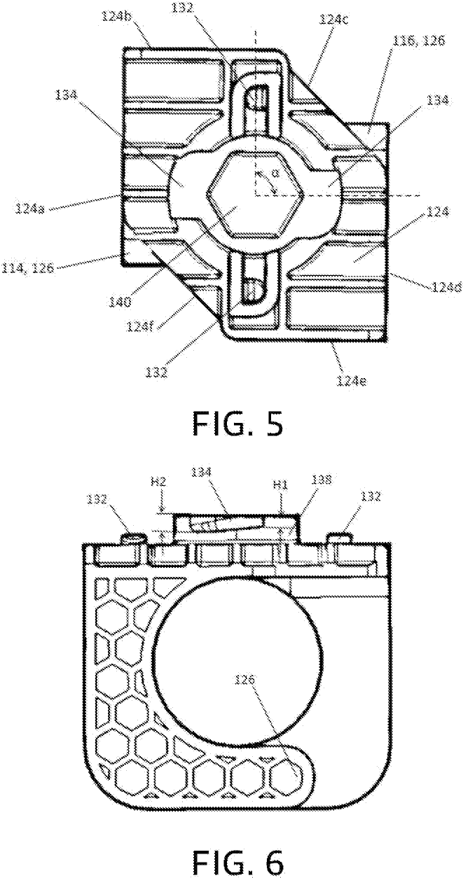

FIG. 5 illustrates a top view of the exemplary attachment member 112 and FIG. 6 illustrates a plan view of the exemplary attachment member 112. A protrusion 138 may extend from the main body 124. The protrusion 138 may include one or more locking wedges 134 that are configured to engage a mating component, such as the cushion pan 106 so that as the attachment member 112 is rotated, the locking wedge 134 may bias the end portion 126 towards the cushion pan 106. The locking wedge 134 may include a ramped surface that is tapered between first and second ends. As an example, the first end may define a first height H1 and the second end may define a second height H2, that may be greater than the first height H1. The protrusion 138 may form a tool interface 140 such as a recess that may be configured to receive an assembly tool. As an example, the tool interface may be a hexagonal recess configured to receive a hex bit or Allen wrench.

In one or more embodiments, the main body 124 may have a substantially hexagonal shape provided with six sidewalls 124a - 124f. The first and the fourth sidewalls 124a, 124d are arranged parallel to the first and second legs 114, 116, respectively. As an example, the first and fourth sidewalls 124a, 124d may be shorter than the third and sixth legs 124c, 124f. The locking tabs 132 and the locking wedges 134 may each extend radially from the protrusion 138 (FIG. 6). As an example, the locking wedges may extend towards the first and fourth sidewalls 124a, 124d

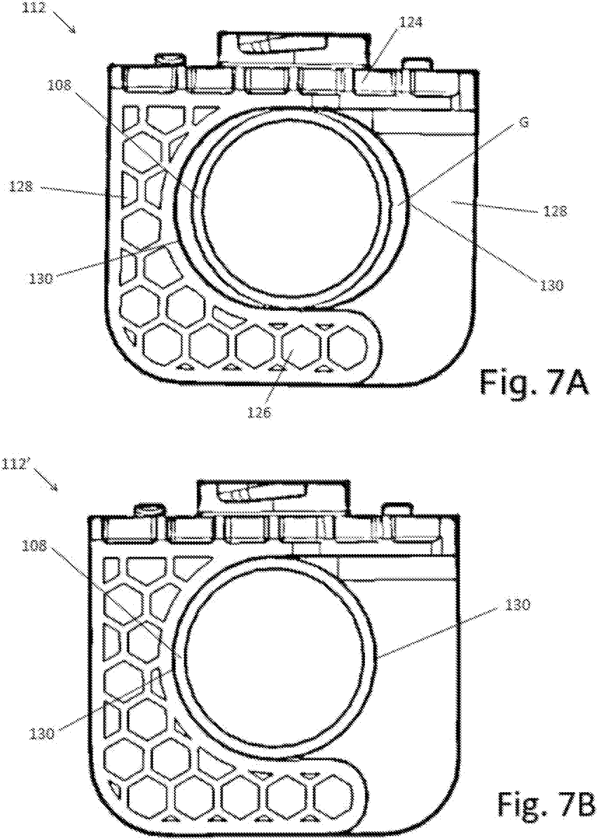

FIG. 7A illustrates a plan view of the attachment member 112 attached to the front cross-tube 108. As stated above, the tilt tube assembly 118 includes the front cross-tube 108 and the front cross-tube 108 may rotate to move, e.g., tilt the cushion pan 106. As the front cross-tube 108 rotates the tube 108 may need to move with respect to the attachment member 112. The curved inner surface 130 may be spaced apart from portions of the tube 108 to form a gap G and to allow the tube 108 to rotate and tilt the cushion pan 106. In seats without tilt adjustment, the tube 108 may not rotate with respect to the cushion pan 106. Accordingly, as illustrated in FIG. 7B, an attachment member 112′ according to another embodiment may be provided. The attachment member 112′ includes curved inner portions 130 that are configured to engage portions of the front cross-tube 108.

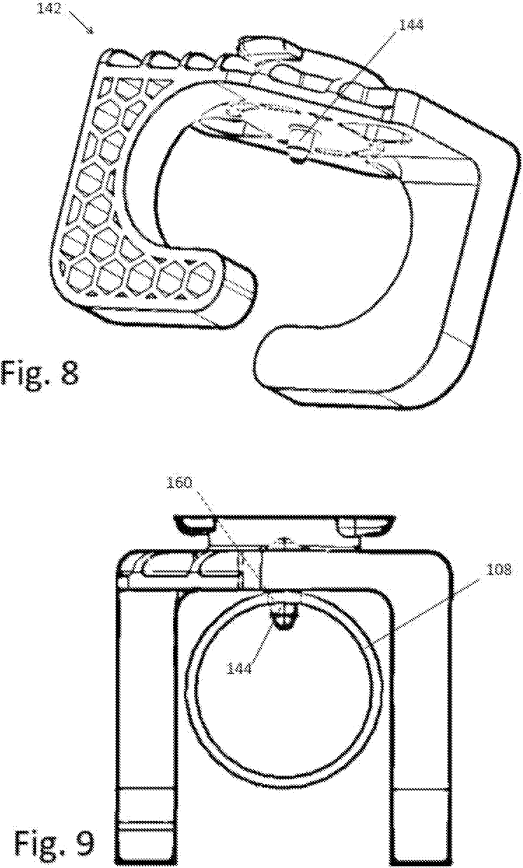

FIGS. 8 - 9 illustrate a perspective view and a plan view, respectively, of an attachment member 142 according to one or more embodiments. The attachment member 142 may include a protrusion 144 that may extend from the main body 124. The protrusion 144 may be configured to extend through a locating aperture 160 defined by the tube 108. The protrusion 144 may be configured to locate the attachment member 142 with respect to the tube 108. As an example, the protrusion 144 may be tapered to ease insertion of the protrusion into the aperture defined by the tube 108. The protrusion 144 may be inserted into the aperture when the attachment member 142 is in an uninstalled position or unlocked position. In the uninstalled or unlocked position, the end portions 126 may not be disposed below the front cross-tube 108.

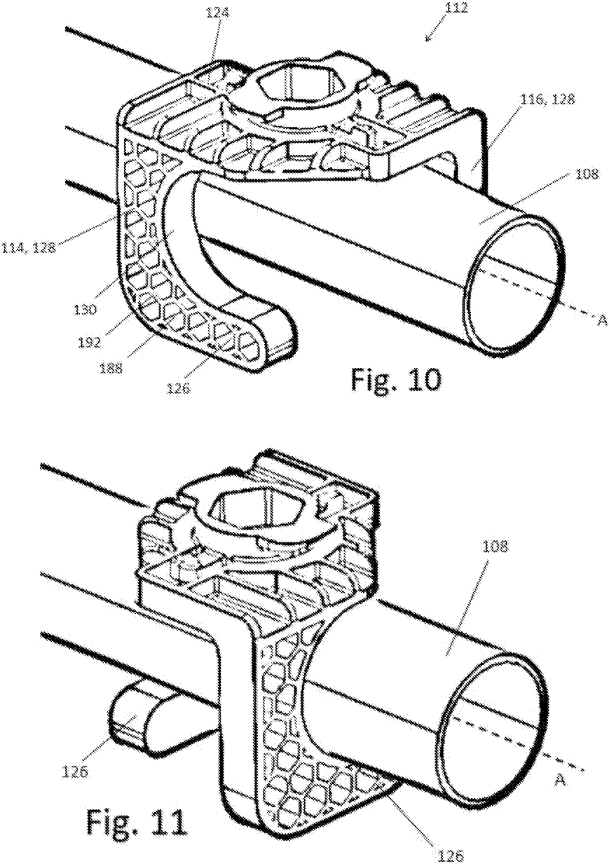

FIG. 10 illustrates a perspective view of the attachment member 112 in an uninstalled position. When the attachment member 112 is in the uninstalled position, the end portions 126 of the attachment member 112 may be positioned parallel to the tube 108 and the main body 124 may lie along a top portion of the tube 108. A dashed line represents a longitudinal axis A of the tube 108. As illustrated, the end portions 126 may extend substantially parallel to the longitudinal axis A when the attachment member 112 is disposed in an uninstalled or unlocked position. In one or more embodiments, the legs 114, 116 or portions 126, 128 of the legs 114, 116 may be provided with one or more hollow cells 188 formed by a number of interconnected walls 192. The interconnected walls 192 and hollow cells 188 may be configured to provide additional strength to the legs 114, 116 that may prevent the legs 114, 116 from giving way under shear or tension loads.

FIG. 11 illustrates a perspective view of the attachment member illustrated in FIG. 8 in an installed position. To install the attachment member 112, the attachment member may be rotated so that the end portions 126 move beneath the tube 108 so that the end portions 126 and the main body 124 sandwich the tube 108. As illustrated, the end portions 126 may extend substantially perpendicular to the longitudinal axis A when the attachment member 112 is disposed in an installed or locked position.

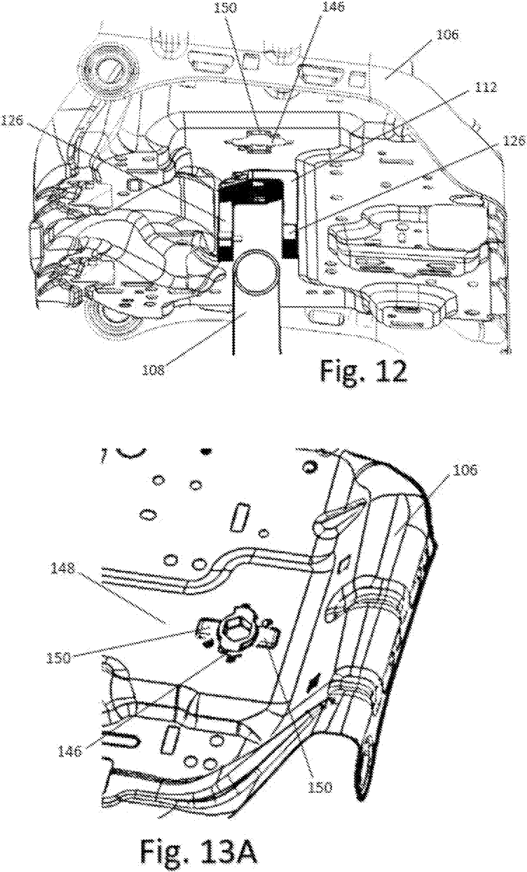

FIG. 12 illustrates an exploded view of a portion of the vehicle seat 100. The cushion pan 106 may define an aperture 146 that may be configured to receive a portion of the attachment member 112 prior to fixing the attachment member 112 to the tube 108. As the attachment member 112 is inserted, the end portions 126 may extend parallel to the tube 108. As will be described in greater detail below, the attachment member 112 may be inserted into the aperture 146 and rotated by a predetermined angle into a loading position so that the attachment member 112 is attached to or retained by the cushion pan 106.

FIG. 13A illustrates a top-perspective view of a portion of the vehicle seat 100 including the attachment member 112 in an uninstalled or loading position. FIG. 13B illustrates a top-perspective view of a portion of the vehicle seat 100 including the attachment member 112 in an installed position. The cushion pan 106 may include a top surface 148 that may form the aperture 146. A number of protrusions 150 may be formed in the top surface 148 of the cushion pan 106 and may be formed to engage one or more of the locking wedges 134 as the attachment member 112 is rotated.

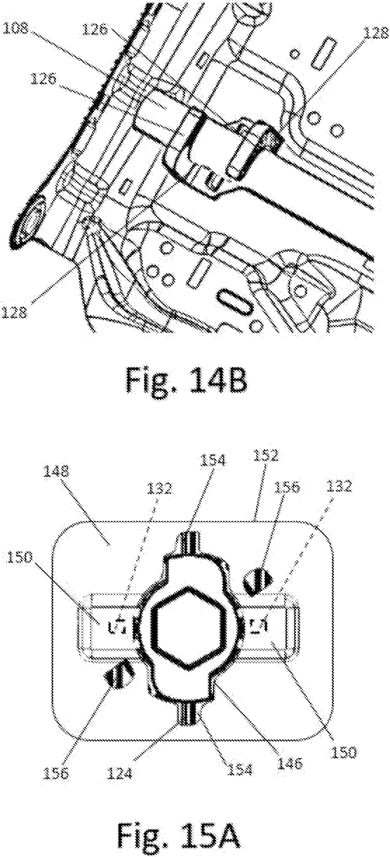

FIG. 14A and FIG. 14B illustrate a bottom-perspective view of a portion of the vehicle seat including the attachment member 112 in an uninstalled position and installed position, respectively. As previously stated, when the attachment member 112 is in the uninstalled or loading position, the end portions 126 may extend parallel to the front cross-tube 108. As the attachment member 112 rotates, the end portions may be positioned orthogonal to the front cross-tube 108. In the installed position, the vertical portions 128 of the attachment member 112 may secure and/or apply a bi-directional force in the fore/aft or Y-direction. The end portions 126 may secure the attachment member 112 and the cushion pan in the vertical or Z-direction.

As an example, as the locking wedge 134 rotates with respect to the cushion pan 106, the attachment member 112 is biased vertically in the Z-direction so that the end portions 126 and main body portion 124 clamp the tube 108. Certain vehicle driving maneuvers, i.e. cornering or quick turns may apply lateral forces to the cushion pan 106 and attachment member 112. Providing a clamping load on tube 108 may prevent or reduce movement of the attachment member 112 and the cushion pan 106 along the tube 108.

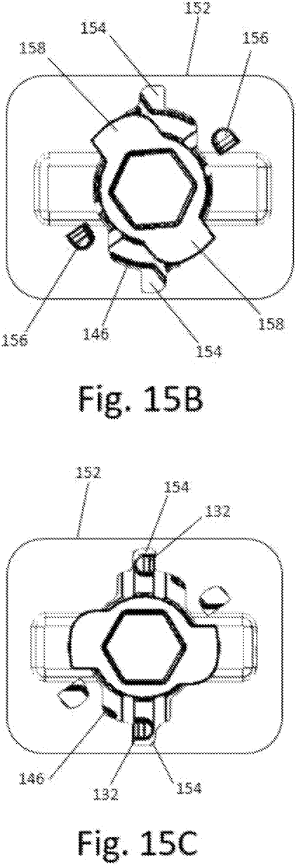

FIGS. 15A - 15C illustrate schematic views of the attachment member 112 and portions of the cushion pan 106. Lines 152 indicate boundaries of portions of the cushion pan 106 that are illustrated in FIGS. 15A - 15C. The cushion pan 106 may include a number of pre-assembly protrusions 156 that may extend from the top surface 148. The protrusions 156 may be configured to engage wings 158 of the attachment member 112 prior to the attachment member being moved to the installed position. The wings 158 of the attachment member 112 may be configured to engage the protrusions 156 if the attachment member 112 rotates inadvertently.

The aperture 146 may include one or more notches 154 that may be configured to receive the locking tabs 132. The locking tabs 132 are represented by dashed lines in FIG. 15A and by solid lines in FIG. 15C. In the uninstalled position, the locking tabs 132 may be disposed below the cushion pan and in the installed position, the locking tabs 132 may be disposed in the notches 154. As one example, the locking tabs 132 may be configured to deflect or bend when the attachment member 112 is in the uninstalled position. Once the attachment member 112 is rotated to the installed position, the locking tabs 132 may spring upwards through the notches 154.

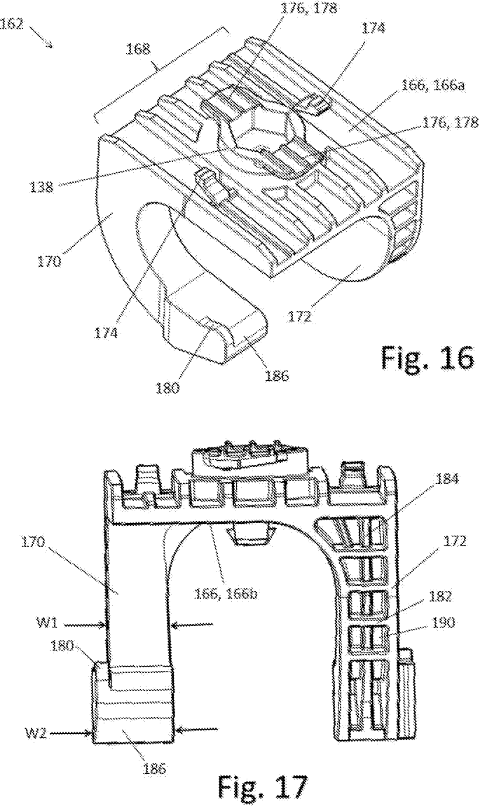

FIG. 16 and FIG. 17 illustrate an attachment member 162 according to one or more embodiments. The attachment member 162 may include a main body 166 provided with a first side 166a and a second side 166b (FIG. 17) that may oppose the first side 166a. The boss 138 may extend from the first side 166a of the main body 166. A number of reinforcement ribs 168 may extend along or be formed integral to the first side 166a of the main body 166. The attachment member 162 may include first and second legs 170, 172 that may extend from the side 166b of the main body 166.

Each of the legs 170, 172 may include a distal portion 186 that may include a locking flange 180. As an example, the distal portion 186 of the first and second legs 170, 172 may be wider than other portions of the first and second legs 170, 172. Portions of the legs 170, 172 that extend from the main body 166 may have a first width W1 and the distal portions 186 may have a second width W2 that may be greater than the first width W1. The first and second legs 170, 172 may include a number of horizontal reinforcement ribs 182 and a number of vertical ribs 184 that may form a number of hollow cells 190. The horizontal and vertical reinforcement ribs 182, 184 that collectively form the cells 190 may provide additional strength to counteract shear and tensile forces applied to the attachment member 162.

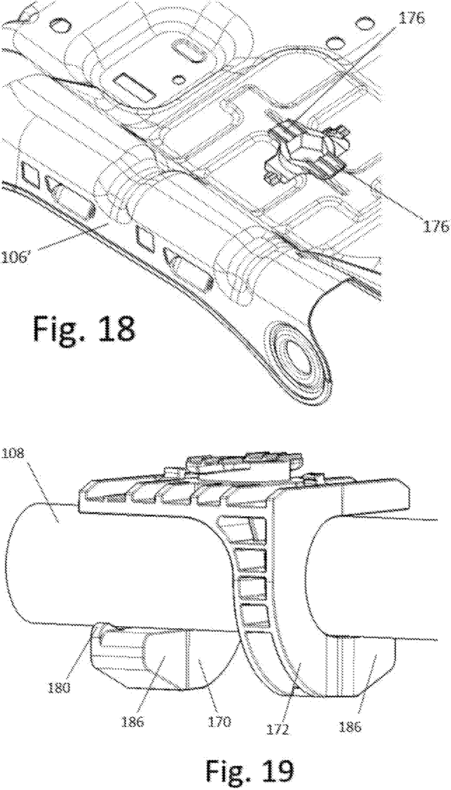

FIG. 18 illustrates a perspective view of the attachment member 162 fixed to another cushion pan 106 in an installed position. In one or more embodiments, the attachment member 162 may include one or more locking tabs 174 that may extend from the first side 166a of the main body 166. The locking tabs 174 may be configured move along a surface of the cushion pan 106′ (FIG. 18) and deflect towards the first side 166a of the main body 166 as the attachment member 162 is moved from the unlocked position to the locked position. A number (e.g., two) locking wings 176 may extend radially from the boss 138. As an example, the locking wings 176 may extend in a direction parallel to the distal portions 186 of the first and second legs 170, 172. The locking wings 176 may include a number of locking wing ribs 178. Arranging the locking wings 176 parallel the first and second legs 170, 172 orients the locking wings 176 to face towards the front and rear portions of the vehicle seat 100. This arrangement may be configured to transfer forces from the attachment member 162 to the cushion pan 106′ to prevent the attachment member 162 from being dislodged from the cushion pan 106′, the tube 108, or both.

FIG. 19 illustrates the attachment member 162 fixed to the tube 108 in the installed position. As discussed above, distal portions 186 of the first and second legs 170, 172 may each include a locking flange 180 that may be arranged to engage and secure the attachment member 162 to the tube 108.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### Parts List

100 vehicle seat
102 backrest assembly
104 cushion support assembly
106 cushion pan
106′ cushion pan
108 front cross - tube
108 tube
110 rear cross - tube
112 attachment member
112′ attachment member
114 legs
116 legs
118 tilt tube assembly
120 link arms
122 side panels
124 main body
124a - 124f
126 end portions
128 vertical portions
130 inner curved portion
132 locking tabs
134 locking wedge
138 protrusion
140 tool interface
142 attachment member
144 protrusion
146 aperture
148 top surface
150 protrusions
152 lines
154 notches
156 pre - assembly protrusions
158 wings
160 locating aperture
162 locking tab opening
164 attachment member
166 main body
166a first side
166b second side
168 reinforcement ribs
170 first leg
172 second leg
174 locking tab
176 locking wing
178 locking wing rib
180 locking flange
182 horizontal rib
184 vertical rib
186 distal portion of leg
188 hollow cells
190 hollow cells
192 interconnected walls

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

What is claimed is:

1. A seat assembly for use in a vehicle, the seat assembly comprising:
a cushion pan configured to support an occupant seated in the seat assembly;
a tube configured to carry the cushion pan;
an attachment member configured to attach the cushion pan to the tube, the attachment member configured to be at least partially inserted into an aperture of the cushion pan and rotated from an unlocked position to a locked position, the attachment member including,
a main body including a first side and a second side opposing the first side, at least a portion of the first side configured to lie against a portion of the cushion pan;
a first leg extending from the second side of the main body; and
a second leg extending from the second side of the main body, wherein in the unlocked position, the first and second legs extend in a first direction parallel to a longitudinal axis of the tube, and in the locked position the first and second legs extend in a second direction substantially transverse to the first direction.

2. The seat assembly of claim 1, wherein the first leg includes a proximal portion and a distal portion, the proximal extending from the second side of the main body and the distal portion extending form the proximal portion in a direction parallel to the second side of the main body.

3. The seat assembly of claim 2, wherein the proximal portion of the first leg defines a first width, and the distal portion of the first leg defines a second width, and the second width is greater than the first width.

4. The seat assembly of claim 2, wherein the distal portion of the first leg includes a locking flange configured to form an interference fit between the distal portion of the first leg and the tube.

5. The seat assembly of claim 2, further comprising:
a first side panel;
a second side panel;
a first link arm pivotally coupled to the first side panel; and
a second link arm pivotally coupled to the second side panel, the first and second link arms each configured to pivot with respect to the first and second side panels to adjust a front portion of the cushion pan, wherein in the locked position the distal portion of the first leg and the second side of the main body each lie against the tube.

6. The seat assembly of claim 2, wherein the proximal portion of the first leg includes a curved inner surface, wherein in the locked position the curved inner surface covers and is spaced apart from a first section of the tube.

7. The seat assembly of claim 6, further comprising:
a first side panel; and
a second side panel, the tube fixed to the first and second side panels, wherein in the locked position the curved inner surface lies along a first section of the tube.

8. The seat assembly of claim 7, further comprising:
a locating protrusion extending from the second side of the main body and configured to be inserted into an aperture defined by the tube.

9. The seat assembly of claim 1, further comprising:
a locking tab extending from the first side of the main body, the locking tab configured to be inserted into a locking-tab aperture defined by the cushion pan.

10. The seat assembly of claim 8, further comprising:
a locking wedge radially extending from a boss extending from and away from the first surface of the main body, wherein the locking tab and the locking wedge are radially spaced apart by at least 30 degrees.

11. The seat assembly of claim 8, wherein the boss defines a recess configured to receive an assembly tool configured to be inserted into the recess and rotated to rotate the attachment member from the unlocked position to the locked position.

12. An attachment member configured to fix a first seat component to a second seat component, the attachment member comprising:
a main body including a first side and a second side opposing the first side;
a locking member disposed above the first side;
a first leg extending from the second side of the main body; and
a second leg extending from the second side of the main body, wherein the second side and end portions of the first and second legs are collectively configured to sandwich the second seat component, wherein the locking member and the first side of the main body are collectively configured to sandwich the first seat component.

13. The attachment member of claim 12, wherein the locking member is a locking wedge spaced apart from the first side of the main body, the locking wedge configured to bias distal portions of at least one of the first and second legs towards the second seat component.

14. The attachment member of claim 13, further comprising:
a boss extending in a vertical direction from the first side of the main body, wherein the locking wedge extends radially from the boss.

15. The attachment member of claim 12, wherein the first leg and the second side are collectively configured to partially surround the second seat component.

16. The attachment member of claim 12, wherein the second seat component is formed by a tube and at least one of the first and second legs include a curved inner portion configured to lie along a portion of the tube.

17. The attachment member of claim 12, wherein the first side includes a plurality of reinforcement ribs.

18. The attachment member of claim 12, wherein the first and second legs are at least partially formed by an array of hollow cells formed between a number of interconnecting walls.

19. The attachment member of claim 18, wherein the array of hollow cells are formed by a number of horizontal reinforcement ribs and a number of vertical reinforcement ribs.

20. A method of assembling a vehicle seat assembly including a cushion pan and a cross tube configured to carry the cushion pan, the method comprising:
providing an attachment member including,
a main body including a first side and a second side opposing the first side,
a pair of opposing legs extending from the second side main body, and
a locking boss extending from the first side of the main body;
inserting the locking boss through an aperture defined by the cushion pan; and
rotating the main body so that the locking boss engages portions of the cushion pan, and the pair of opposing legs at least partially surround portions of the cross tube.
